(19) United States
(12) Patent Application Publication
(10) Pub. No.: US 2026/0101250 A1
(43) Pub. Date: Apr. 9, 2026

(54) CELL SELECTION METHOD AND APPARATUS

(71) Applicant: GUANGDONG OPPO MOBILE TELECOMMUNICATIONS CORP., LTD., Dongguan (CN)

(72) Inventor: Hao LIN, Neuilly-Sur-Seine (FR)

(21) Appl. No.: 19/417,662

(22) Filed: Dec. 12, 2025

Related U.S. Application Data
(63) Continuation of application No. PCT/IB2023/000415, filed on Jun. 19, 2023.

(51) Int. Cl. H04W 36/04; H04W 24/10

(52) U.S. Cl. CPC H04W 36/04; H04W 24/10

(57) ABSTRACT

A cell selection method includes selecting, by a user equipment (UE), a cluster-based cell, where the cluster-based cell includes a plurality of clusters, and selecting, by the UE, one or more initial clusters from the plurality of clusters within the cluster-based cell.

### CROSS-REFERENCE TO RELATED APPLICATION

This application is a Continuation Application of International Application No. PCT/IB2023/000415 filed on June 19, 2023, which is incorporated herein by reference in its entirety.

### TECHNICAL FIELD

The present disclosure relates to the field of communication systems, and more particularly, to cell selection methods and apparatuses, which can provide an initial access for a cluster-based cell.

### BACKGROUND

In order to cover a wide area, network operators need to deploy more base stations, which can be costly due to the need for additional infrastructure and maintenance. As a result, the deployment of networks can become an expensive undertaking, and network operators need to carefully weigh the benefits of high-speed data rates against the costs of infrastructure deployment. Therefore, there is a need of infrastructure sharing for future operators to maintain a good technology-based system coverage while envisioning an affordable deployment expense.

### SUMMARY

In a first aspect of the present disclosure, a cell selection method includes selecting, by a user equipment (UE), a cluster-based cell, wherein the cluster-based cell includes a plurality of clusters and selecting, by the UE, one or more initial clusters from the plurality of clusters within the cluster-based cell.

In a second aspect of the present disclosure, a user equipment (UE) includes a selector configured to: select a cluster-based cell, wherein the cluster-based cell includes a plurality of clusters, and select one or more initial clusters from the plurality of clusters within the cluster-based cell. In some embodiments, the UE is configured to perform any one of the above methods.

In a third aspect of the present disclosure, a UE includes a memory, a transceiver, and a processor coupled to the memory and the transceiver. The processor is configured to perform any one of the above methods.

In a fourth aspect of the present disclosure, an infrastructure sharing device includes an executer configured to perform an infrastructure sharing between a first deployer and a second deployer using a blockchain. In some embodiments, the infrastructure sharing device is configured to perform any one of the above methods.

In a fifth aspect of the present disclosure, an infrastructure sharing device includes a memory, a transceiver, and a processor coupled to the memory and the transceiver. The processor is configured to perform any one of the above methods.

In a sixth aspect of the present disclosure, a wireless communication device includes an adjuster configured to adjust a right of a spectrum block using a blockchain. Further, the spectrum management device is configured to perform any one of the above methods.

In a seventh aspect of the present disclosure, a wireless communication device includes an executor configured to perform any one of the above methods.

In an eighth aspect of the present disclosure, a non-transitory machine-readable storage medium has stored thereon instructions that, when executed by a computer, cause the computer to perform any one of the above methods.

In a ninth aspect of the present disclosure, a chip includes a processor, configured to call and run a computer program stored in a memory, to cause a device in which the chip is installed to execute any one of the above methods.

In a tenth aspect of the present disclosure, a non-transitory computer readable storage medium, in which a computer program is stored, causes a computer to execute any one of the above methods.

In an eleventh aspect of the present disclosure, a computer program product includes a computer program, and the computer program causes a computer to execute any one of the above methods.

In a twelfth aspect of the present disclosure, a computer program causes a computer to execute any one of the above methods.

### BRIEF DESCRIPTION OF DRAWINGS

In order to illustrate the embodiments of the present disclosure more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram of a coverage comparison between mmW and first frequency range (FR1) frequency band according to an embodiment of the present disclosure.

FIG. 2 is a schematic diagram of a distributed massive multiple-input multiple-output (MIMO) structure according to an embodiment of the present disclosure.

FIG. 3A is a block diagram of a UE in a communication network system according to an embodiment of the present disclosure.

FIG. 3B is a block diagram of an infrastructure sharing device in a communication network system according to an embodiment of the present disclosure.

FIG. 4A is a flowchart illustrating a cell selection method according to an embodiment of the present disclosure.

FIG. 4B is a flowchart illustrating an infrastructure sharing method according to an embodiment of the present disclosure.

FIG. 5 is a schematic diagram of infrastructure sharing according to an embodiment of the present disclosure.

FIG. 6 is a schematic diagram of infrastructure sharing according to an embodiment of the present disclosure.

FIG. 7A is a schematic diagram of infrastructure sharing according to an embodiment of the present disclosure.

FIG. 7B is a schematic diagram of infrastructure sharing according to an embodiment of the present disclosure.

FIG. 8A is a schematic diagram of infrastructure sharing according to an embodiment of the present disclosure.

FIG. 8B is a schematic diagram of infrastructure sharing according to an embodiment of the present disclosure.

FIG. 9 is a schematic diagram of a cluster-based cell according to an embodiment of the present disclosure.

FIG. 10 is a schematic diagram of a cell-selection and an initial cluster selection according to an embodiment of the present disclosure.

FIG. 11A is a block diagram of a UE according to an embodiment of the present disclosure.

FIG. 11B is a block diagram of an infrastructure sharing device according to an embodiment of the present disclosure.

FIG. 12 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. The terminologies in the embodiments of the present disclosure are merely for describing the purpose of the certain embodiment, but not to limit the disclosure.

### Technical problem

Millimeter wave (mmW) technology is being widely adopted for next-generation wireless networks due to its ability to offer high-speed data rates. However, one of the major drawbacks of mmW is its limited coverage range, which is significantly shorter than other frequency bands used for wireless communication. An example of coverage comparison is illustrated in FIG. 1, where mmW frequency band and first frequency range (FR1) frequency band coverage difference is presented. This means that to cover a wide area, network operators need to deploy more base stations, which can be costly due to the need for additional infrastructure and maintenance. As a result, the deployment of mmW networks can become an expensive undertaking, and the network operators need to carefully weigh the benefits of high-speed data rates against the costs of infrastructure deployment. In the present disclosure, some embodiments present a method for the future operators to maintain a good mmW technology-based system coverage while envisioning an affordable deployment expense.

With the infrastructure sharing, the cell range of an operator can be virtually extended to a large extend. Therefore, from a UE point of view, the actual cell may be large. This may result in one or more consequences: 1) since the synchronization signal block (SSB) and random access channel (RACH) occasion are per-cell configured, when the cell range is large, the UEs within the same cell may be complete out of synchronization between the UEs, this may cause interference between the UEs; 2) due to the large number of remote antenna (AP) within a cell, data collected from each AP may be treated in the same control central processing unit (CPU), leading to a huge computation burden for the network.

### Blockchain

A blockchain is a type of distributed ledger technology (DLT) that includes growing lists of records, called blocks, that are securely linked together using cryptography. Each block contains a cryptographic hash of the previous block, a timestamp, and transaction data (generally represented as a Merkle tree, where data nodes are represented by leaves). The timestamp proves that the transaction data existed when the block was created. Since each block contains information about the previous block, they effectively form a chain (compare linked list data structure), with each additional block linking to the ones before it. Consequently, blockchain transactions are irreversible in that, once they are recorded, the data in any given block cannot be altered retroactively without altering all subsequent blocks.

Blockchains can be managed by a peer-to-peer (P2P) computer network for use as a public distributed ledger, where nodes collectively adhere to a consensus algorithm protocol to add and validate new transaction blocks. Blockchain records are not unalterable, since blockchain forks are possible, blockchains may be considered secure by design and exemplify a distributed computing system with high byzantine fault tolerance.

### mmW

Millimeter wave (mmW) refers to a specific range of electromagnetic frequencies between 30 GHz and 300 GHz. This range of frequencies is considered a high-frequency band and is being increasingly explored for various wireless communication applications due to its ability to support high-speed data transfer and low latency. mmW technology is particularly promising for the implementation of 5G networks and beyond, as it can provide multi-gigabit-per-second data transfer rates, which is several times faster than the current 4G long term evolution (LTE) networks. The use of mmW technology can also enable the development of new applications and services, such as augmented reality and virtual reality, which require large amounts of data to be transferred in real-time. However, the use of mmW technology also presents various challenges, such as signal attenuation and interference, which need to be addressed in order to fully realize its potential. Overall, mmW technology holds great promise for revolutionizing wireless communication and enabling a wide range of innovative applications.

### Distributed massive MIMO

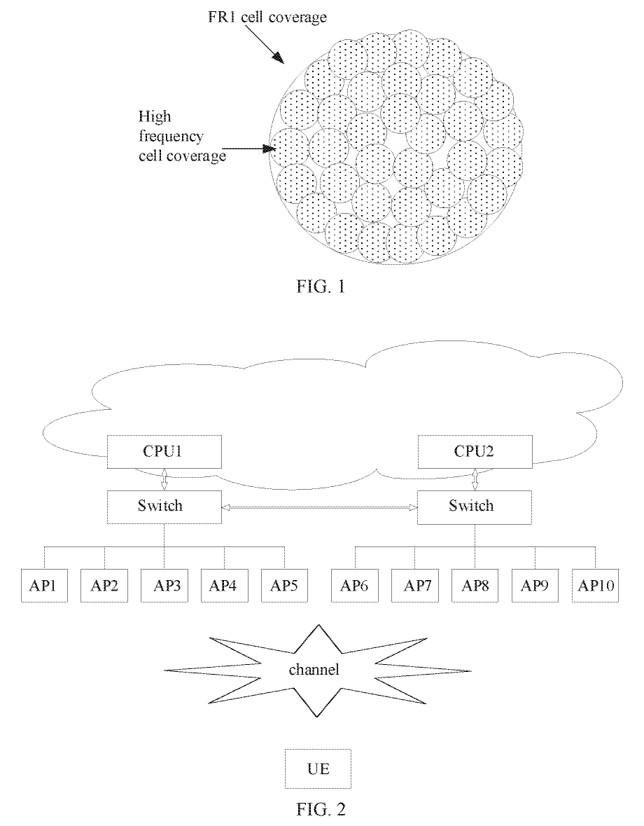

Distributed massive multiple-input multiple-output (MIMO) is a cutting-edge technology that promises to revolutionize the way wireless communication is carried out. FIG. 2 is a distributed massive multiple-input multiple-output (MIMO) structure according to an embodiment of the present disclosure. FIG. 2 illustrates that, in some embodiments, the distributed massive MIMO structure involves deploying a large number of antennas across a wide area and using advanced signal processing algorithms to enable efficient and high-quality communication between devices. The technology has the potential to significantly increase the capacity and coverage of wireless networks, while reducing interference and energy consumption.

Distributed massive MIMO is particularly suited for use in crowded and dense urban environments, where traditional cellular networks often struggle to provide adequate coverage and bandwidth. By utilizing multiple antennas and sophisticated beamforming techniques, distributed massive MIMO can provide high-speed and reliable connectivity to a large number of devices.

However, implementing distributed massive MIMO poses several challenges, such as the need for a large number of antennas and complex signal processing algorithms, which require significant computational power and energy. Nevertheless, with continued advances in technology, the potential benefits of distributed massive MIMO are expected to outweigh its challenges, paving the way for a new era of wireless communication.

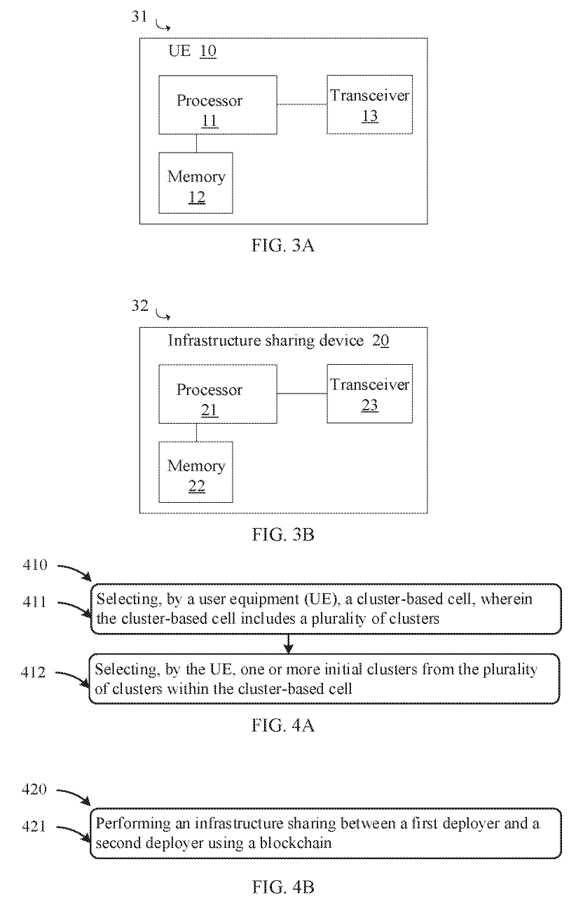

FIG. 3A illustrates that, in some embodiments, a UE 10 in a communication network system 31 (e.g., non-terrestrial network (NTN) or terrestrial network) according to an embodiment of the present disclosure is disclosed. The communication network system 31 includes the UE 10. The UE 10 may include a memory 12, a transceiver 13, and a processor 11 coupled to the memory 12 and the transceiver 13. The processor 11 may be configured to implement proposed functions, procedures and/or methods described in this description. Layers of radio interface protocol may be implemented in the processor 11. The memory 12 is operatively coupled with the processor 11 and stores a variety of information to operate the processor 11. The transceiver 13 is operatively coupled with the processor 11, and the transceiver 13 transmits and/or receives a radio signal.

The processor 11 may include application-specific integrated circuit (ASIC), other chipset, logic circuit and/or data processing device. The memory 12 may include read-only memory (ROM), random access memory (RAM), flash memory, memory card, storage medium and/or other storage device. The transceiver 13 may include baseband circuitry to process radio frequency signals. When the embodiments are implemented in software, the techniques described herein can be implemented with modules (e.g., procedures, functions, and so on) that perform the functions described herein. The modules can be stored in the memory 12 and executed by the processor 11. The memory 12 can be implemented within the processor 11 or external to the processor 11 in which case those can be communicatively coupled to the processor 11 via various means as is known in the art.

In some embodiments, the processor 11 is configured to configured to select a cluster-based cell, wherein the cluster-based cell includes a plurality of clusters, and select one or more initial clusters from the plurality of clusters within the cluster-based cell. This can provide a good communication performance, provide high reliability, provide infrastructure sharing, improve interference between user equipments (UEs), improve synchronization between UEs within the same cell, and/or improve a computation burden for a network. In some embodiments, the UE 10 is configured to perform the following methods.

FIG. 3B illustrates that, in some embodiments, an infrastructure sharing device 20 in a communication network system 32 (e.g., non-terrestrial network (NTN) or terrestrial network) according to an embodiment of the present disclosure is disclosed. The communication network system 32 includes the infrastructure sharing device 20. The infrastructure sharing device 20 may include a memory 22, a transceiver 23, and a processor 21 coupled to the memory 22 and the transceiver 23. The processor 21 may be configured to implement proposed functions, procedures and/or methods described in this description. Layers of radio interface protocol may be implemented in the processor 21. The memory 22 is operatively coupled with the processor 21 and stores a variety of information to operate the processor 21. The transceiver 23 is operatively coupled with the processor 21, and the transceiver 23 transmits and/or receives a radio signal.

The processor 21 may include application-specific integrated circuit (ASIC), other chipset, logic circuit and/or data processing device. The memory 22 may include read-only memory (ROM), random access memory (RAM), flash memory, memory card, storage medium and/or other storage device. The transceiver 23 may include baseband circuitry to process radio frequency signals. When the embodiments are implemented in software, the techniques described herein can be implemented with modules (e.g., procedures, functions, and so on) that perform the functions described herein. The modules can be stored in the memory 22 and executed by the processor 21. The memory 22 can be implemented within the processor 21 or external to the processor 21 in which case those can be communicatively coupled to the processor 21 via various means as is known in the art.

In some embodiments, the processor 21 is configured to configured to perform an infrastructure sharing between a first deployer (such as a network operator A in FIG. 6) and a second deployer (such as a network operator B in FIG. 6) using a blockchain. This can provide infrastructure sharing. In some embodiments, the infrastructure sharing device 20 is configured to perform the following methods.

FIG. 4A illustrates a cell selection method 410 according to an embodiment of the present disclosure. In some embodiments, the method 410 includes: a block 411, selecting, by a user equipment (UE), a cluster-based cell, wherein the cluster-based cell includes a plurality of clusters, and a block 412, selecting, by the UE, one or more initial clusters from the plurality of clusters within the cluster-based cell. This can provide a good communication performance, provide high reliability, provide infrastructure sharing, improve interference between user equipments (UEs), improve synchronization between UEs within the same cell, and/or improve a computation burden for a network.

In some embodiments, the method further includes performing, by the UE, an initial access procedure within selected one or more initial clusters if the UE is connected to cluster-based cell. In some embodiments, the selected one or more initial clusters include a plurality of remote antennas (APs), and the method further includes performing, by the UE, AP-based measurement and reporting on the selected one or more initial clusters. In some embodiments, the method further includes reporting, by the UE to a network, one or more AP-based measurement results associated with the AP-based measurement and reporting on the selected one or more initial clusters. In some embodiments, the method further includes being configured, by the UE from the network, with a UE-dedicated cluster based on the one or more AP-based measurement results. In some embodiments, the UE-dedicated cluster is associated with AP-grouping.

In some embodiments, selecting, by the UE, the cluster-based cell further includes selecting, by the UE, the cluster-based cell and a first stage raster point. In some embodiments, selecting, by the UE, the one or more initial clusters from the plurality of clusters within the cluster-based cell further includes selecting, by the UE, the one or more initial clusters from the plurality of clusters within the cluster-based cell and one or more second stage raster points. In some embodiments, the one or more second stage raster points include one or more cluster-based raster points. In some embodiments, the first stage raster point is associated with the one or more second stage raster points.

In some embodiments, the first stage raster point includes a first frequency point, the one or more second stage raster points include one or more second frequency points, and the first frequency point is associated with the one or more second frequency points. In some embodiments, one or more second stage raster point locations are pre-defined or pre-configured. In some embodiments, if the one or more second stage raster point locations are pre-defined, the UE determines the one or more second stage raster point locations based on the first stage raster point. In some embodiments, if the one or more second stage raster point locations are pre-configured, the UE determines a system information carried in the cluster-based cell associated with the one or more second stage raster point, and the UE determines the one or more second stage raster point locations based on the system information carried in the cluster-based cell.

In some embodiments, a first part of the one or more second stage raster points is shifted by an offset and/or a step from the first stage raster point; and/or a second part of the one or more second stage raster points is the offset and/or the step from the first part of the one or more second stage raster points, where the offset and/or the step is pre-configured or pre-defined. In some embodiments, the UE is configured to determine one or more second stage reference signals at the one or more second stage raster points, and the one or more second stage reference signals include cluster information of the selected one or more initial clusters. In some embodiments, the one or more second stage reference signals include one or more synchronization signal blocks (SSBs). In some embodiments, each of the one or more SSBs includes a primary synchronization signal (PSS) and a secondary synchronization signal (SSS), and the PSS and/or the SSS is used to determine the cluster information.

In some embodiments, the method further includes performing, by the UE, a physical channel occasion to monitor a physical channel, wherein the physical channel schedules a system information for the UE to perform the initial access procedure within selected one or more initial clusters. In some embodiments, the physical channel occasion includes a type 0 physical downlink control channel (PDCCH) occasion, and the physical channel includes a type 0 PDCCH. In some embodiments, a resource for the physical channel occasion is associated with the one or more second stage reference signals. In some embodiments, at the one or more second stage raster points, the UE is configured to receive the one or more second stage reference signals with one or more reference signal indexes. In some embodiments, the physical channel occasion is associated with the one or more reference signal indexes of the one or more second stage reference signals.

In some embodiments, when the UE determines the one or more initial clusters, the UE detects the one or more second stage reference signals, determines the one or more reference signal indexes, and the UE monitors the physical channel in the physical channel occasion associated with the one or more reference signal indexes. In some embodiments, the UE is configured to receive a system information including a random access channel (RACH) occasion (RO) configuration from the network, and the RO is associated with the one or more reference signal indexes. In some embodiments, the method further includes performing an infrastructure sharing between a first deployer and a second deployer using a blockchain. In some embodiments, the infrastructure sharing includes that a shared remote antenna and/or a shared fronthaul belonging to the second deployer is used for a first user equipment (UE) belonging to the first deployer.

In some embodiments, the shared fronthaul is a link between a base station and the shared remote antenna. In some embodiments, the blockchain includes a consortium chain, the first deployer and the second deployer both belong to consortium chain members of the consortium chain, or the first deployer and the second deployer are both approved by the consortium chain. In some embodiments, performing the infrastructure sharing between the first deployer and the second deployer uses a smart contract. In some embodiments, the smart contract is created by the first deployer. In some embodiments, the smart contract contains an infrastructure sharing information. In some embodiments, the infrastructure sharing information includes at least one of following information: a radio frequency (RF) performance of the shared remote antenna, a location of the shared remote antenna, a sharing duration, a geographic location, a switch location of the base station, a frequency band, a sharing type, a sharing fees information, or a sharing trade.

In some embodiments, the shared remote antenna and/or the shared fronthaul belonging to the second deployer is agreed to be shared by the second deployer, the smart contract is called by the second deployer if a condition is verified, the smart contract is executed, and a sharing permission is established. In some embodiments, the smart condition includes a license identifier (ID) that that is approved when the shared remote antenna verifies a requirement. In some embodiments, the sharing type includes an exclusive sharing for the first deployer to use the shared remote antenna and/or the shared fronthaul. In some embodiments, the sharing type includes a non-exclusive sharing for the first deployer to use the shared remote antenna and/or the shared fronthaul. In some embodiments, a time pattern is defined in the smart contract to partition usage periods for the first deployer and the second deployer, respectively.

FIG. 4B illustrates an infrastructure sharing method 420 according to an embodiment of the present disclosure. In some embodiments, the method 420 includes: a block 421, performing an infrastructure sharing between a first deployer and a second deployer using a blockchain. This can provide infrastructure sharing.

In some embodiments, the infrastructure sharing includes that a shared remote antenna and/or a shared fronthaul belonging to the second deployer is used for a first user equipment (UE) belonging to the first deployer. In some embodiments, the shared fronthaul is a link between a base station and the shared remote antenna. In some embodiments, the blockchain includes a consortium chain, the first deployer and the second deployer both belong to consortium chain members of the consortium chain, or the first deployer and the second deployer are both approved by the consortium chain. In some embodiments, performing the infrastructure sharing between the first deployer and the second deployer uses a smart contract. In some embodiments, the smart contract is created by the first deployer.

In some embodiments, the smart contract contains an infrastructure sharing information. In some embodiments, the infrastructure sharing information includes at least one of following information: a radio frequency (RF) performance of the shared remote antenna, a location of the shared remote antenna, a sharing duration, a geographic location, a switch location of the base station, a frequency band, a sharing type, a sharing fees information, or a sharing trade. In some embodiments, the shared remote antenna and/or the shared fronthaul belonging to the second deployer is agreed to be shared by the second deployer, the smart contract is called by the second deployer if a condition is verified, the smart contract is executed, and a sharing permission is established.

In some embodiments, the smart condition includes a license identifier (ID) that that is approved when the shared remote antenna verifies a requirement. In some embodiments, the sharing type includes an exclusive sharing for the first deployer to use the shared remote antenna and/or the shared fronthaul. In some embodiments, the sharing type includes a non-exclusive sharing for the first deployer to use the shared remote antenna and/or the shared fronthaul. In some embodiments, a time pattern is defined in the smart contract to partition usage periods for the first deployer and the second deployer, respectively.

The examples given in this disclosure can be applied for IoT device, NB-IoT device, NR device, LTE device, but the present disclosure is not limited thereto.

### Examples

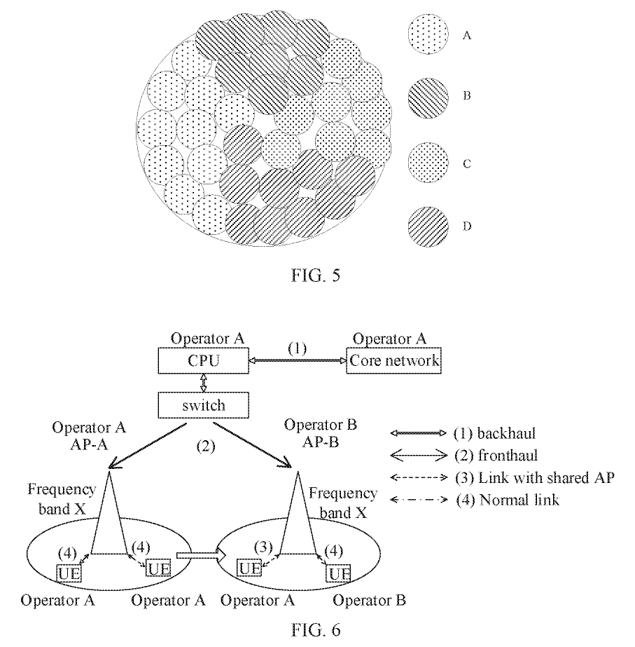

In order to resolve the above technical problem, such as the issue of high expense associated with deploying mmW networks, a possible solution is to share the infrastructure deployment among multiple network operators. By sharing the cost of infrastructure, operators can significantly reduce the cost of deploying mmW networks while still reaping the benefits of high-speed data rates. This approach can be particularly beneficial for smaller operators who may not have the resources to deploy mmW networks independently. In addition, sharing infrastructure can lead to more efficient use of resources, thereby reducing the overall environmental impact of network deployment. However, for this approach to be successful, operators need to work together to ensure that the infrastructure is deployed in a coordinated and efficient manner to avoid interference and other issues that could impact network performance. As illustrated in FIG. 5, four operators share their infrastructure to provide a full coverage but in theory only pay 25% of the deployment cost.

As illustrated in FIG. 6, the method of infrastructure sharing aiming operators is that assuming an operator (operator A) deploys core network, which is connected to a base station. The base station can be considered as a control central processing unit (CPU) equipped with a switch, which further connects with multiple remote antennas (APs). The link between the switch and the AP is called fronthaul (FH). In some examples, assuming that the operator A deploys an AP (AP-A) and the FH connecting the switch and the AP-A. While another operator (operator B) also deploys an AP (AP-B) connecting to the same switch. In this example, from the coverage point of view, the coverage is extended by the AP-A and the AP-B but the deployment cost for the operator A is reduced due to that the cost for the FH between the switch and the AP-B is paid by the operator B. As the AP-B is linked to the switch, the operator A may use the AP-B for serving a UE belong to the operator A. As for the operator B, its infrastructure, in some examples, the AP-B and the corresponding FH, are shared by the operator A. Thus, it is called infrastructure sharing among operators.

For example, when a UE belong to the operator A (UE-A), which is served by the AP-A within AP-A’s coverage. When the UE moves outside the coverage of the AP-A and enters AP-B’s coverage, the operator A may use the AP-B to continue serving the UE. Thus, the coverage is extended.

### Infrastructure sharing method

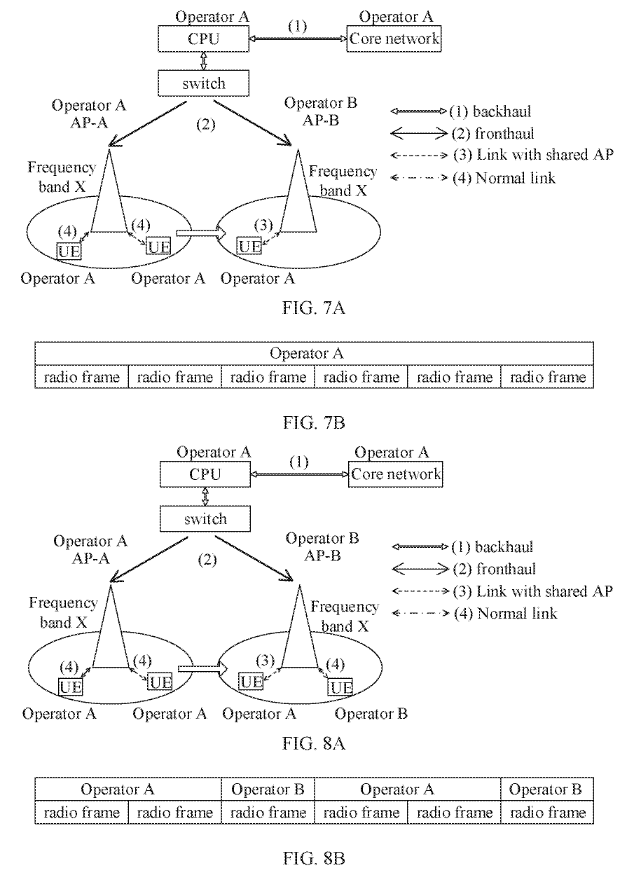

The infrastructure sharing can be realized by blockchain technology. For example, the operator A and the operator B both belong to a consortium chain member, and the operator A may create a smart contract, which contains the required AP information, such as RF performance, location, etc. Optionally, information is also about the sharing duration, geographic location, switch location, frequency band, sharing type, etc. Moreover, the smart contract also contains sharing fees information. FIG. 7A illustrates that, in some examples, when the operator B agrees to share its AP and FH, the operator B can call for the smart contract if the condition is verified, the smart contract may be executed, and the sharing permission is established. The condition may be a license ID for which it is approved that the shared AP verifies the requirement. The sharing trade may be recorded in the blockchain as well.

There may be different types of sharing. In one example, once an AP and a FH are shared by the operator A, there is a long-term exclusive sharing as illustrated in FIG. 7A and FIG. 7B. This means that the operator B cannot use the AP for its own use during the sharing period.

FIG. 8A and FIG. 8B illustrate that, in another example, the sharing period is non-continued and it inter-changed with the operator B use period. In this example, the operator A and the operator B both can use the AP-B to service for their own UEs. In this example, there may be a collision at the AP-B for both operators A and B in case they intend to use at the same time. To resolve this issue, a time pattern may be defined in the smart contract to partition the usage period for operators A and B, respectively.

In some embodiments, the infrastructure sharing trade is realized over blockchain. First of all, the initial operator and other operator or suppler, etc. who wants to be the potential new operator should be a node in a blockchain dedicated to infrastructure sharing trading. One example is that such blockchain could be a consortium chain and the consortium can be established by the government authority, operators, blockchain infrastructure builders, etc. To become a node over the blockchain, one needs to become a consortium member or be approved by the consortium. A node can have a node account with an account address, which serves as an identity of the node. In the account, there may be one or more information for the trading, such as the account balance which is used for the trade payment and information relevant to authentication, where the authentication is used to prove that the user is allowed to participate to the trading. This authentication may be issued by the government authority or other party. The user can be authenticated if certain conditions are met. For example, one condition could be the certification to test when the operator uses the infrastructure, its equipment satisfies the regulation, is controlled out-of-band interference requirement, or conforms to a standard of a target/requested technology, e.g., new radio (NR), a 3GPP technology, or a Wi-Fi or an IEEE technology. The trading can take the form of auction or non-auction. For auction trading, an operator may set an initial price for the target spectrum chunk and call for auction. The potential operators can bid for the utilization right. The auction process is described as follows: the operator (such as operator A in FUG. 6) creates a smart contract for the auction and shares the smart contract address to all the nodes who are interested to participate to the auction. In some embodiments, creating the smart contract for the auction is based on a technology dimension. In some embodiments, the technology dimension includes one or more technologies to be used in the spectrum block. In some embodiments, the one or more technologies include at least new radio (NR), a 3GPP technology, or a Wi-Fi or an IEEE technology.

the form of auction or non-auction. For auction trading, an operator may set an initial price for the target spectrum chunk and call for auction. The potential operators can bid for the utilization right. The auction process is described as follows: the operator (such as operator A in FUG. 6) creates a smart contract for the auction and shares the smart contract address to all the nodes who are interested to participate to the auction. In some embodiments, creating the smart contract for the auction is based on a technology dimension. In some embodiments, the technology dimension includes one or more technologies to be used in the spectrum block. In some embodiments, the one or more technologies include at least new radio (NR), a 3GPP technology, or a Wi-Fi or an IEEE technology.

In the smart contract, it may precise all the granularity information as previously presented and the conditions to call the smart contract are at least one of the followings: 1) the consortium member; 2) the operator account has enough money in his balance account to trigger the bid; or 3) the operator has authentication to participate the trade. In some embodiments, money includes a coin or a token.

The smart contract may be programs stored on a blockchain that run when one or more predetermined conditions are met. The smart contract is used to automate the execution of an agreement so that all participants can be immediately certain of the outcome, without any intermediary’s involvement or time loss. The smart contact can also automate a workflow, triggering a next action when one or more conditions are met.

Coins refer to any cryptocurrency that has a standalone, independent blockchain, like Bitcoin. These cryptocurrencies are bootstrapped from scratch, and the broader network is designed explicitly to achieve a certain goal. For example, Bitcoin exists as a censorship-resistant store of value and medium of exchange that has a secure, fixed monetary policy. The native token of Bitcoin, BTC (i.e., bitcoins), is the most liquid cryptocurrency in the market and has both the highest market cap and realized market cap in the cryptocurrency sector. Coin projects typically draw inspiration from past technologies or other cryptocurrencies and fuse them into an innovative network catering to a specific purpose. Another example of a coin, Ethereum’s Ether (ETH) is the native coin of a smart contracts platform for creating general-purpose computer programs that run on a decentralized blockchain. Rather than focusing on financial data, Ethereum focuses on arbitrary program data that can cover anything from games to social media. Ether is used for sending/receiving, managing assets, paying gas fees, and interacting with decentralized applications on the network.

Tokens are a unique outlay of broader smart contracts platforms like Ethereum that enable users to create, issue, and manage tokens that are derivatives of the primary blockchain. Tokens occupy a unique corner of the cryptocurrency market where they function as “utility” tokens within an application’s ecosystem for incentivizing certain behavior or paying fees. A token may refer to a digital unit of value that represents an asset or utility. Unlike coins, tokens do not have their own blockchain and are issued on top of existing networks. Unlike coins, tokens are not mined in the process of transaction validation. Instead, they are minted.

Other than these, the smart contract may contain other information such as bidding expiration time or remaining time; holder ID or holder signature; holder smart contract account address; the bid amount each time is contract is called/triggered. After creating the smart contract, the smart contract can be published over the blockchain by blockchain miner. In return, the holder may obtain a contract address, with which the potential users can call the smart contract. The holders may share the address with the potential users. As a potential user, he can use the smart contract address to trigger the smart contract for bidding the auction. Once the smart contract is triggered, it may first check if the expiration time is met, if so, the user can no longer trigger the smart contract. But if not, the smart contract may continue to check if the user conditions are all met, the smart contract can automatically execute the fee transaction of an amount of the pre-defined bid from the user balance account to the smart contract account and updates the latest user ID (or address) with the highest bid. When the auction expiration time is over, the smart contract may automatically transfer the final amount of bided money from the smart contract account to the holder account and at the same time returns the money to the account of all the users who lost the auction. Then the smart contract may record the data about the infrastructure sharing fees transaction in the ledger and also the smart contract may update the infrastructure sharing data structure.

For non-auction, on the other hand, the non-auction requests a fixed trading fee. It means that when the smart contract is called/triggered by a user (such as an operator), the transaction may be conducted, and the utilization right can be issued. Similarly, to call the smart contract, the user conditions must be met such as the user’s money in the balance account must be equal to or greater than the requested trading fee; the user needs to obtain the authentication. In this case, it is to note that when multiple users successfully called the smart contract, the utilization right may be issued to multiple users. When there are multiple users obtain the infrastructure sharing within a same frequency chunk for a same time period and geographic location, the user needs to perform collision avoidance access rule, such as listen-before-talk (LBT). The smart contract can be created to control the number of the users so that the collision level may not be high. For example, the holder (such as an operator) may set a maximum number of calling the smart contract, every time the smart contract is successfully called by a user, the number may be decremented until zero. Once the number reaches zero, the smart contract cannot be called/triggered again, achieving the control of the number of users that are issued (granted) with infrastructure sharing.

In another example, when an operator obtains the infrastructure sharing via the above described process, the user may be allowed to further trade his right in a second market.

FIG. 9 illustrates a cluster-based cell according to an embodiment of the present disclosure. FIG. 9 illustrates that, in some embodiments, a technical solution is provided to cut a cluster-based cell into partitions, where each partition is called a cluster. The cluster size can be configured by the network such that the UE within a cluster connecting to any AP of the cluster with an approximately similar round trip time, or the TA difference is within a certain threshold. For an idle UE, when the UE tries to connect to a cluster-based cell, the UE may first select an initial cluster of the cluster-based cell. Note that the cluster-based cell may contain one or more initial clusters.

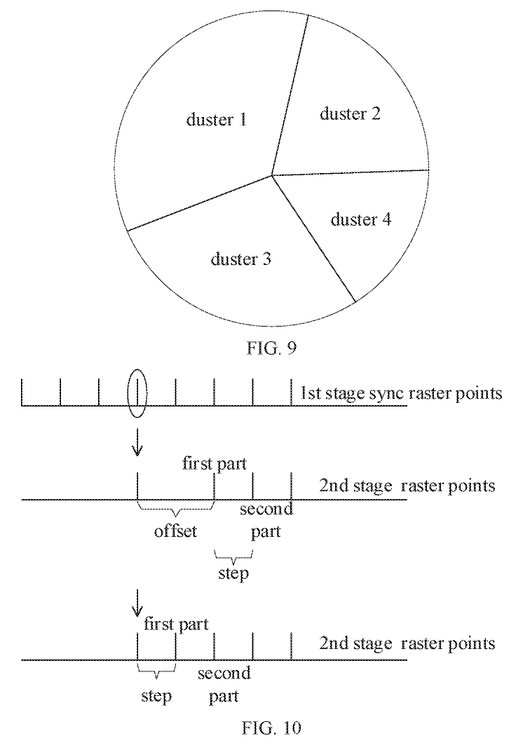

FIG. 10 illustrates a cell-selection and an initial cluster selection according to an embodiment of the present disclosure. In some embodiments, the overall procedure is as follows: the idle UE first selects a cell to connect, then selects an initial cluster within the cell. The UE performs the initial access procedure within the selected initial cluster until the UE is connected to the cell. Then the UE can be configured to perform AP-based measurement and reporting. Finally, the network can configure UE-dedicated cluster (AP-grouping) for the UE, based on the reported measurement results.

### Cell-selection and initial cluster selection

In legacy cell selection, the UE measures the SSB at pre-defined synchronization raster. In some embodiments of this disclosure, the UE performs a 2-stage searching. The first stage is similar to the legacy cell selection; while in the second stage, the UE searches for a suitable initial cluster. As illustrated in FIG. 10, the legacy sync raster can be determined as a 1st stage raster and once the UE selects a cell (also selecting the corresponding 1st stage raster point), the 1st stage raster point is associated with one or more 2nd stage raster points (we call it cluster raster). The one or more 2nd stage raster points locations are pre-defined or pre-configured with respect to the 1st stage raster point.

In some embodiments, the first stage raster point includes a first frequency point, the one or more second stage raster points include one or more second frequency points, and the first frequency point is associated with the one or more second frequency points. In some embodiments, one or more second stage raster point locations are pre-defined or pre-configured. In some embodiments, if the one or more second stage raster point locations are pre-defined, the UE determines the one or more second stage raster point locations based on the first stage raster point.

In some embodiments, if the one or more second stage raster point locations are pre-configured, the UE determines a system information carried in the cluster-based cell associated with the one or more second stage raster point, and the UE determines the one or more second stage raster point locations based on the system information carried in the cluster-based cell.

One example of the association includes wherein a first 2nd stage raster point (or called a first part of the 2nd stage raster point) is shifted by an offset and/or a step from the 1st stage raster point and/or a second 2nd stage raster point (or called a second part of the 2nd stage raster point) is the step from the first 2nd stage raster point, where the offset and/or the step can be pre-configured or pre-defined.

At the 2nd stage raster point, the UE may need to search for one or more 2nd stage reference signals, wherein the reference signal may contain the corresponding cluster information, e.g., cluster ID. One example of this reference signal can be SSB, where the PSS and/or SSS can be used to determine the cluster ID. We call such SSB as 2nd stage SSB.

### RACH occasion and cluster association

After the UE selects the initial cluster, the UE needs to determine the PDCCH occasion to monitor Type0 PDCCH, which schedules the system information for the UE to perform the initial access procedure. In some embodiments of this disclosure, the resource for type 0 PDCCH occasion is associated with the 2nd stage reference signal, e.g., 2nd stage SSB. One example is that at one 2nd stage raster point, the UE may receive one or more 2nd stage SSBs with different SSB index. The Type 0 PDCCH monitoring occasion should be associated with the SSB index of the 2nd stage SSBs. When the UE determines an initial cluster, the UE detects one or more 2nd stage SSBs and decides one SSB index and starts to monitor type 0 PDCCH in type 0 PDCCH occasion associated with this SSB index. When the UE receives system information such as the SIB1, in which the RACH occasion (RO) configuration is provided by the network, where the RO is associated with the 2nd stage SSB index.

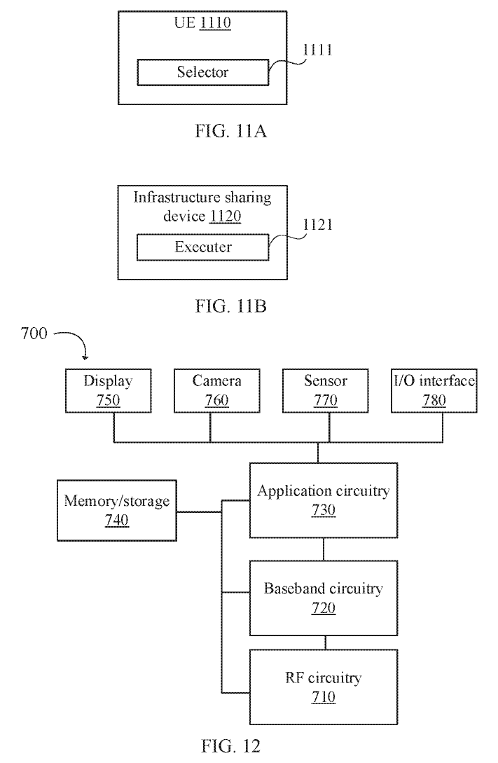

FIG. 11A illustrates a UE 1110 according to an embodiment of the present disclosure. The UE 1110 includes a selector 1111 configured to configured to: select a cluster-based cell, wherein the cluster-based cell includes a plurality of clusters, and select one or more initial clusters from the plurality of clusters within the cluster-based cell. In some embodiments, the UE is configured to perform any one of the above methods. This can provide a good communication performance, provide high reliability, provide infrastructure sharing, improve interference between user equipments (UEs), improve synchronization between UEs within the same cell, and/or improve a computation burden for a network. In some embodiments, the UE 1110 is configured to perform any one of the above methods.

FIG. 11B illustrates an infrastructure sharing device 1120 according to an embodiment of the present disclosure. The infrastructure sharing device 1120 includes an executer 1121 configured to perform an infrastructure sharing between a first deployer and a second deployer using a blockchain. This can provide infrastructure sharing. In some embodiments, the infrastructure sharing device 1120 is configured to perform any one of the above methods.

Commercial interests for some embodiments are as follows. 1. Improving the spectrum utilization efficiency. 2. Providing flexible spectrum sharing. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms. Further, this can provide a good communication performance, provide high reliability, provide infrastructure sharing, improve interference between user equipments (UEs), improve synchronization between UEs within the same cell, and/or improve a computation burden for a network.

FIG. 12 is a block diagram of an example system 700 for wireless communication according to an embodiment of the present disclosure. Embodiments described herein may be implemented into the system using any suitably configured hardware and/or software. FIG. 12 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with

one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with exemplary embodiments, it is understood that the present disclosure is not limited to the disclosed embodiments but is intended to cover various arrangements made without departing from the scope of the broadest interpretation of the appended claims.

What is claimed is:

1. A cell selection method, comprising:
selecting, by a user equipment (UE), a cluster-based cell, wherein the cluster-based cell comprises a plurality of clusters; and
selecting, by the UE, one or more initial clusters from the plurality of clusters within the cluster-based cell.

2. The method of claim 1, further comprising performing, by the UE, an initial access procedure within selected one or more initial clusters if the UE is connected to the cluster-based cell.

3. The method of claim 2, wherein the selected one or more initial clusters comprise a plurality of remote antennas (APs), and the method further comprises performing, by the UE, AP-based measurement and reporting on the selected one or more initial clusters.

4. The method of claim 3, further comprising:
reporting, by the UE to a network, one or more AP-based measurement results associated with the AP-based measurement and reporting on the selected one or more initial clusters; and
being configured, by the UE from the network, with a UE-dedicated cluster based on the one or more AP-based measurement results; wherein the UE-dedicated cluster is associated with AP-grouping.

5. The method of claim 1, wherein selecting, by the UE, the cluster-based cell further comprises selecting, by the UE, the cluster-based cell and a first stage raster point.

6. The method of claim 5, wherein selecting, by the UE, the one or more initial clusters from the plurality of clusters within the cluster-based cell further comprises selecting, by the UE, the one or more initial clusters from the plurality of clusters within the cluster-based cell and one or more second stage raster points.

7. The method of claim 6, wherein the one or more second stage raster points comprise one or more cluster-based raster points; or
the first stage raster point is associated with the one or more second stage raster points; or
the first stage raster point comprises a first frequency point, the one or more second stage raster points comprise one or more second frequency points, and the first frequency point is associated with the one or more second frequency points.

8. The method of claim 6, wherein one or more second stage raster point locations are pre-defined or pre-configured; wherein
if the one or more second stage raster point locations are pre-defined, the UE determines the one or more second stage raster point locations based on the first stage raster point; or
if the one or more second stage raster point locations are pre-configured, the UE determines a system information carried in the cluster-based cell associated with the one or more second stage raster point, and the UE determines the one or more second stage raster point locations based on the system information carried in the cluster-based cell.

9. The method of claim 6, wherein a first part of the one or more second stage raster points is shifted by an offset and/or a step from the first stage raster point; and/or a second part of the one or more second stage raster points is the offset and/or the step from the first part of the one or more second stage raster points, where the offset and/or the step is pre-configured or pre-defined.

10. The method of claim 6, wherein the UE is configured to determine one or more second stage reference signals at the one or more second stage raster points, and the one or more second stage reference signals comprise cluster information of the selected one or more initial clusters.

11. The method of claim 10, wherein the one or more second stage reference signals comprise one or more synchronization signal blocks (SSBs);
wherein each of the one or more SSBs comprises a primary synchronization signal (PSS) and a secondary synchronization signal (SSS), and the PSS and/or the SSS is used to determine the cluster information.

12. The method of claim 2, further comprising:
performing, by the UE, a physical channel occasion to monitor a physical channel, wherein the physical channel schedules a system information for the UE to perform the initial access procedure within selected one or more initial clusters.

13. The method of claim 12, wherein the physical channel occasion comprises a type 0 physical downlink control channel (PDCCH) occasion, and the physical channel comprises a type 0 PDCCH; or
a resource for the physical channel occasion is associated with the one or more second stage reference signals.

14. The method of claim 13, wherein at the one or more second stage raster points, the UE is configured to receive the one or more second stage reference signals with one or more reference signal indexes;
wherein the physical channel occasion is associated with the one or more reference signal indexes of the one or more second stage reference signals.

15. The method of claim 14, wherein when the UE determines the one or more initial clusters, the UE detects the one or more second stage reference signals, determines the one or more reference signal indexes, and the UE monitors the physical channel in the physical channel occasion associated with the one or more reference signal indexes.

16. The method of claim 14, wherein the UE is configured to receive a system information comprising a random access channel (RACH) occasion (RO) configuration from the network, and the RO is associated with the one or more reference signal indexes.

17. A user equipment (UE), comprising:
a memory;
a transceiver; and
a processor coupled to the memory and the transceiver;
wherein the processor is configured to perform:
selecting a cluster-based cell, wherein the cluster-based cell comprises a plurality of clusters; and
selecting one or more initial clusters from the plurality of clusters within the cluster-based cell.

18. The UE of claim 17, wherein the processor is further configured to perform an initial access procedure within selected one or more initial clusters if the UE is connected to the cluster-based cell.

19. The UE of claim 18, wherein the selected one or more initial clusters comprise a plurality of remote antennas (APs), and the processor is further configured to perform AP-based measurement and reporting on the selected one or more initial clusters.

20. A non-transitory machine-readable storage medium having stored thereon instructions that, when executed by a computer, cause the computer to perform:
selecting a cluster-based cell, wherein the cluster-based cell comprises a plurality of clusters; and
selecting one or more initial clusters from the plurality of clusters within the cluster-based cell.
